(19) United States
(12) Patent Application Publication
(10) Pub. No.: US 2012/0223104 A1
(43) Pub. Date: Sep. 6, 2012

(54) FLUID PRODUCT DISPENSER

(75) Inventors: Romain Bertin, Evreux (FR); Sophie Feschet-Magdelaine, Evreux (FR); Patrick Muller, Saint Aubin Sur Gaillon (FR)

(73) Assignee: VALOIS SAS, Le Neubourg (FR)

(21) Appl. No.: 13/509,116

(22) PCT Filed: Nov. 9, 2010
(86) PCT No.: PCT/FR10/52400

§ 371 Date: May 10, 2012

(30) Foreign Application Priority Data
Nov. 13, 2009 (FR) 09 57990

(51) Int. Cl. B67D 7/06; B23P 11/00

(52) U.S. Cl. 222/183; 29/428

(57) ABSTRACT

A fluid dispenser including a fluid reservoir including a neck with a constricted opening that communicates with an inside volume; and a dispenser member including a fluid inlet that is provided with a dip tube, the dip tube provided with a substantially-plane flexible sheet having shape memory. The sheet presents a transverse dimension, in the direction that is perpendicular to the dip tube, that is greater than the dimension of the constricted opening, such that the sheet must be caused to take up a deformed configuration in order to pass through the neck, and must then relax into a substantially-plane rest configuration inside the inside volume. The sheet presents a bottom edge having a portion that, in the rest configuration, penetrates into the constricted opening to initiate the deformation of the sheet, so as to bring it subsequently into its deformed configuration.

The present invention relates to a dispenser for dispensing fluid, e.g. in the form of a spray, the dispenser comprising a fluid reservoir that defines a neck on which, or in which, there is mounted a dispenser member, such as a pump or a valve. This type of dispenser is very frequently used in the fields of perfumery, cosmetics, or even pharmacy, for dispensing fluids that are very varied.

In order to deliver the fluid contained in the reservoir to the pump or the valve, a dip tube is generally used, which dip tube is connected to the fluid inlet of the pump or the valve, and extends down inside the fluid reservoir to the proximity of, or into contact with, its bottom wall. The dip tube may be visible, or, in a variant, it may be invisible when dipped in the fluid.

Document U.S. Pat. No. 5,915,600 discloses a fluid dispenser having a dip tube that is used as a support for a decorative element that can be seen by the user inside the reservoir. Naturally, this implies that the fluid is transparent, or at least translucent, and that the wall of the reservoir is also transparent or translucent. In that prior-art document, the decorative element includes one or more bores dimensioned so that the dip tube may be inserted through the bores as a force-fit. Thus, the decorative element is held inside the reservoir by means of the dip tube that serves as a support.

In the above-mentioned document, the decorative elements represent animals (salamander—killer whale) in three dimensions (3D), but it is not clear how the decorative elements are inserted into the reservoir through its neck.

Document U.S. Pat. No. 5,937,554 is also known, which describes a fluid dispenser having a reservoir that contains a decoration sheet that acts in combination with the front and/or rear wall(s) of the reservoir to constitute a complex decoration presenting a depth of field.

An object of the present invention is to define a dispenser having a reservoir that contains a decorative element that is insertable into the reservoir in easy, rapid, industrializable, and automatic manner. An object of the present invention is to overcome the prior-art drawbacks associated with inserting the decorative element into the reservoir. As mentioned above, the first prior-art document U.S. Pat. No. 5,915,600 is not realistic about inserting the decorative element into the reservoir, let alone in automatic manner. With regard to the second prior-art document U.S. Pat. No. 5,937554, the insertion of the decoration may lead to said decoration being poorly positioned inside the reservoir. Consequently, an object of the present invention is not only easy insertion of the decorative element inside the reservoir, but also correct and repeated positioning inside the reservoir.

In the prior-art, document WO 97/03887 is also known, which describes a rectangular film that has rounded bottom corners, so as to make it easier to insert the film into a container. In a variant embodiment, the film is fastened onto a dip tube, rolled-up on the tube, and held in the rolled-up state by an adhesive, prior to being inserted into the container. The rounded corners merely prevent the film from butting against the top edge of the neck of the container, and the adhesively-bonded rolled-up variant is difficult to use.

An object of the present invention is to cause the film or sheet to be deformed in systematic and automatic manner so as to guarantee that it is inserted automatically and positioned accurately inside the reservoir or container, without any risk of the film or sheet being damaged (torn and/or folded).

In order to achieve these objects, the present invention proposes a fluid dispenser comprising: a fluid reservoir including a neck that defines a constricted opening that communicates with an inside volume of greater size; and a dispenser member, such as a pump or a valve, including a fluid inlet that is provided with a dip tube, the dip tube being provided with a substantially-plane flexible sheet having shape memory, the sheet presenting a transverse dimension, in the direction that is perpendicular to the dip tube, that is greater than the dimension of the constricted opening, such that the sheet must be caused to take up a deformed configuration in order to pass through the neck, and must then relax into a substantially-plane rest configuration inside the inside volume; the sheet presenting a bottom edge having a portion that, in the rest configuration, penetrates into the constricted opening in such a manner as to initiate the deformation of the sheet, so as to bring it subsequently into its deformed configuration. The term “flexible sheet” should be understood to mean any mainly two dimensional (2D) element that presents thickness that is small compared to its width and to its height. The flexible sheet may be formed from a single sheet, or, in a variant, it may be made from a plurality of sheets or films that are bonded together, e.g. by adhesive or by heat sealing. The flexible sheet may be fastened to the dip tube at one or more localized points, or, in a variant, the sheet may be fastened to the dip tube substantially over its entire height. In any event, it is preferable for the sheet to extend along the dip tube. Advantageously, the sheet is rolled up around a dip tube in its deformed configuration.

Preferably, the bottom edge of the sheet is rounded or pointed at the portion that penetrates into the constricted opening. Surprisingly, but empirically confirmed, the portion of the bottom edge of the sheet that penetrates into the constricted opening makes it possible to initiate the rolling-up of the sheet, so that it penetrates through the neck of the reservoir without any difficulty. The deformation imposed on the sheet is repeatable at will, without any risk of deteriorating the sheet and/or the dip tube, e.g. by creasing. Consequently, the sheet may be inserted into the reservoir industrially in automatic manner, as is not possible with the above-mentioned prior-art dispensers. The rounded or pointed shape of the portion of the bottom edge that penetrates into the constricted opening is only one possible embodiment, but nevertheless it does offer good results.

In an advantageous embodiment, the sheet comprises at least two films, each of which extends on a respective side of the dip tube. With regard to fastening the sheet on the dip tube, it is possible to envisage any appropriate technique, such as adhesive, heat-sealing, clamping, or clipping, for example.

The spirit of the invention resides in using the dip tube to insert the decorative element through the neck of the reservoir in a configuration that is deformed during the insertion operation itself.

The invention is described more fully below with reference to the accompanying drawings which show two embodiments of the invention by way of non-limiting example.

In the figures:

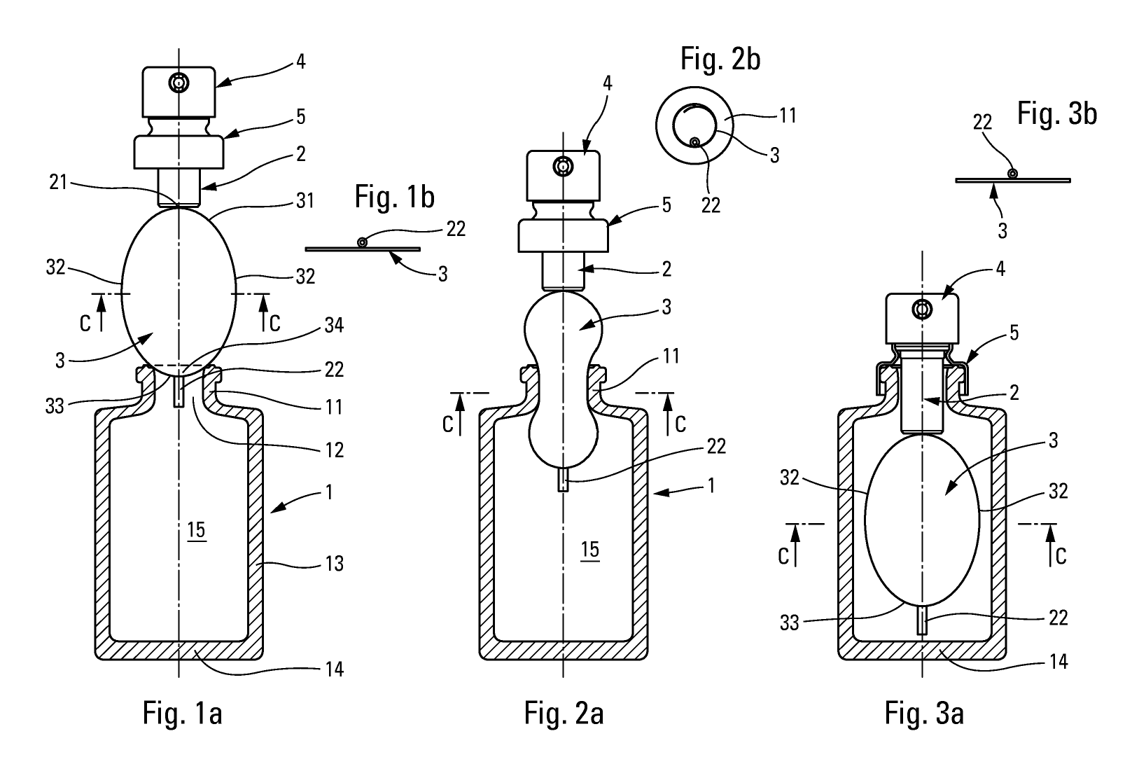

FIG. 1a is a diagrammatic view of a fluid dispenser just before the operation of inserting the flexible sheet through the neck of the reservoir;

FIG. 1b is a view on section line C-C of FIG. 1a, through the flexible sheet and the dip tube;

FIG. 2a is a view similar to the view in FIG. 1a during the insertion operation, with the flexible sheet located in the neck of the reservoir;

FIG. 2b is a view on section line C-C of FIG. 2a, through the neck of the reservoir, the flexible sheet, and the dip tube;

FIG. 3a is a view of the dispenser in FIGS. 1a and 2a in the mounted state, with the decorative element inside the reservoir;

FIG. 3b is a view on section line C-C of FIG. 3a, through the flexible sheet and the dip tube;

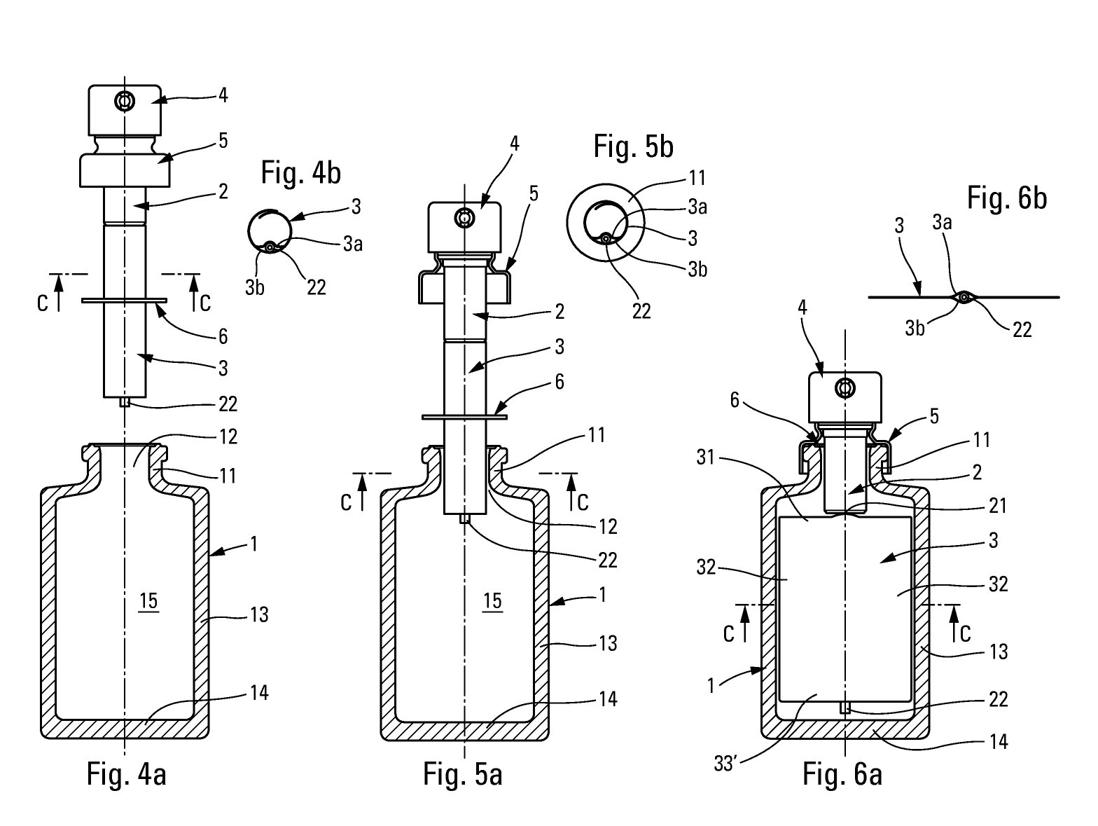

FIG. 4a is a view similar to Figure la for a second embodiment that does not form part of the invention;

FIG. 4b is a view on section line C-C of FIG. 4a, through the flexible sheet and the dip tube;

FIG. 5a is a view similar to FIG. 2a, showing the flexible sheet in the rolled-up state being inserted through the neck of the reservoir;

FIG. 5b is a view on section line C-C of FIG. 5a, through the neck of the reservoir, the rolled-up flexible sheet, and the dip tube;

FIG. 6a is a view similar to FIG. 3a, showing the dispenser in the mounted state, with the flexible sheet deployed inside the reservoir; and

FIG. 6b is a view on section line C-C of FIG. 6a, through the deployed flexible sheet and the dip tube;

In the two embodiments shown in the figures, the fluid dispenser of the invention comprises: a fluid reservoir 1; a dispenser member 2; a flexible sheet 3; a dispenser head or pusher 4; and a fastener ring 5. The reservoir 1, the dispenser member 2, the pusher 4, and the fastener ring 5 may be identical or similar in both embodiments. Only the flexible sheet 3 differs from one embodiment to the other, and especially its method of being inserted into the reservoir.

The fluid reservoir 1 may be of a type that is entirely conventional for the fields of perfumery or cosmetics. The reservoir 1 includes a neck 11 that defines a constricted opening 12 that puts the outside into communication with an inside volume 15 that is defined inside the reservoir. More precisely, the inside volume 15, for filling with fluid, is defined by a peripheral side wall 13 that is closed at its bottom end by a bottom wall 14 that may be placed on any surface, defining the upright position of the reservoir. In these embodiments, the neck 11 is arranged at the end remote from the bottom wall 14, but this configuration is not limiting. It should be observed that the constricted opening 12, that is generally circular, presents a size that is substantially smaller than the size of the inside volume 15 at the side wall 13. This characteristic is entirely conventional in the fields of perfumery and cosmetics. The reservoir 1 may be made from various materials, such as glass or a plastics material, for example. The reservoir is transparent or at least translucent. The reservoir 1 may be circularly symmetrical about an axis that passes through the neck 11 and the bottom wall 14. In a variant, the reservoir may be asymmetrical, in full or in part. An essential characteristic of the reservoir is that the neck 11 defines an opening 12 that is constricted compared to the size of the inside volume 15.

The dispenser member 2 may be a pump or a valve. Given that the structure of the dispenser member is not critical to the present invention, it is not described in detail below. However, it may be mentioned that the dispenser member 2 includes a fluid inlet 21 that is provided with a dip tube 22 that is for extending down within the inside volume 15 of the reservoir to the proximity of, or even into contact with, the bottom wall 14. The dip tube 22 may be connected by interfitting with the fluid inlet 21. The dip tube 22 is in the form of a flexible tube made of plastics material such as polyethylene, for example. In some configurations, when it is desired for the dip tube 22 to be transparent inside the fluid of the reservoir, it may be made out of a fluoropolymer such as ethylene fluorinated ethylene propylene (EFEP), for example.

Although not shown in the figures, the dispenser member 2 includes an actuator rod that is axially movable down and up. The actuator rod is covered by a dispenser head or pusher 4 on which the user may press by means of one or more fingers so as to actuate the dispenser member 2. The pusher 4 may incorporate a dispenser orifice, e.g. in the form of a spray nozzle, as shown in the figures.

In order to hold the dispenser member 2 in stable and leaktight manner on the neck 11 of the reservoir, the fastener ring 5 is used, which fastener ring comprises firstly reception means for securely receiving the dispenser member 2, and secondly fastener or catch means for forming a leaktight fastening on the neck 11. In the embodiment used to illustrate the present invention, the fastener ring 5 is a metal crimping ring that crimps around the neck 11 that advantageously presents an annular peripheral rib that is provided for this purpose. Instead of the metal crimping ring, it is also possible to use a metal or plastic screw-fastener ring, or even a snap-fastener ring. The technique for fastening the fastener ring 5 is not critical to the present invention.

In both embodiments in the figures, the dip tube 22 of the dispenser member 2 is provided with a flexible sheet 3 that constitutes a decorative element that is visible in the fluid and through the fluid reservoir 1. Advantageously, the substantially-plane flexible sheet 3 presents shape memory. In other words, when the sheet 3 is not subjected to any stress, it is completely or substantially plane, such that the decorative element may be described as being essentially 2D. The thickness of the sheet 3 is small, or even tiny, compared to its other two dimensions, namely its width and its height. In the invention, the sheet 3 extends along the dip tube, as can be seen very clearly in FIGS. 3a and 6a. It can also be said that the dip tube extends over the height of the flexible sheet 3. The flexible sheet 3 is connected to the dip tube at one or more localized points. In a variant, the flexible sheet 3 may be connected to the dip tube over its entire height. Without being limiting, it is possible to use various fastening techniques, such as adhesive, heat-sealing, clamping, or clipping, for example. Nevertheless, it is advantageous for the flexible sheet 3 to be connected to the dip tube 22 at least at its bottom and/or top end. The flexible sheet 3 may be made from a single sheet of a material that is compatible with the fluid contained in the reservoir 1. In a variant, the flexible sheet may be made from a plurality of films that are connected together in the form of a laminated sheet of films. It is also possible to imagine that the sheet 3 comprises two films, each of which extends on a respective side of the dip tube, so that said dip tube is covered completely by the flexible sheet 3. In both embodiments in the figures, the flexible sheet 3 may be defined as presenting a top edge 31 that is arranged in the proximity of the fluid inlet 21, two side edges 32, and a bottom edge 33 that is closest to the bottom end of the dip tube 22. In the invention, the width of the flexible sheet 3, measured between its two side edges 32, is greater than the diameter of the constricted opening 12 of the neck 11. This can be seen easily in FIGS. 1a, 3a, and 6a. In its rest configuration, the side edges 32 of the flexible sheet 3 may be situated in the proximity of, or even in contact with, the side wall 13 of the reservoir 1. Given that the width of the sheet 3 is greater than the diameter of the neck 11, the technical difficulty behind the invention is to insert the flexible sheet 3 into the inside volume 15 of the reservoir 1 in a manner that is easy, rapid, repetitive, industrializable, and capable of being automated, and without any risk of damaging the flexible sheet 3, while guaranteeing that it is positioned properly inside the reservoir.

Reference is made firstly to FIGS. 1a to 3b in order to describe a first embodiment of the present invention. With reference to FIGS. 1a and 1b, it should be observed that the flexible sheet 3 is in its rest configuration, i.e. completely or substantially plane. Its width, measured between its two side edges 32, is considerably greater than the diameter of the constricted opening 12. The sheet 3 is still plane, but its bottom edge 33 is already in contact with the top edge to the neck 11. It should thus be observed that a portion 34 of the bottom edge 33 has already penetrated into the constricted opening 12 of the neck 11, while the sheet 3 is still not being subjected to any stress. It should be observed that the edge 33 at the portion 34 is rounded, with a bottom point that is clearly situated inside the neck 11. In the embodiment used to illustrate the present invention, the bottom point of the bottom edge 33 is situated at the dip tube 22. Instead of a rounded bottom edge, it is also possible to envisage a flexible sheet 3 with a bottom edge that is pointed or angular, but that still penetrates into the neck 11 in the plane rest configuration of the sheet. It has been observed empirically that the portion 34 of the bottom edge 33 penetrating into the neck 11 makes it possible to initiate the deformation of the flexible sheet 3, in such a manner as to enable the sheet to pass through the neck 11, as can be seen in FIG. 2a. The flexible sheet 3 is thus in a deformed configuration, and more particularly is rolled-up around the dip tube 22 that is used as a support, a stiffener, and a winding axis for the sheet 3. This can be seen clearly in FIG. 2b. By continuing to drive the sheet 3 into the reservoir 1, the position shown in FIG. 3a is finally reached, in which position the flexible sheet 3 is once again in its plane rest configuration, as can be seen in FIG. 3b. In a variant, it is possible to make a flexible sheet 3 with a width, measured between its two side edges 32, that is greater than the dimension of the reservoir 15, such that the sheet 3 does not return completely into its plane rest configuration once inside the reservoir.

Thus, it is shown above that the portion 34 of the flexible sheet 3 performs a particularly important role while the sheet is being inserted through the neck 11, given that it constitutes a kind of “deformation starter” for the sheet, that, in combination with the dip tube 22, imposes a very particular type of deformation, namely the rolling-up of the sheet around the dip tube 22. It is thus indeed the combination of the portion 34 with the dip tube 22 that makes it possible to deform the sheet in imposed and repetitive manner, so as to enable it to be passed through the constricted opening 12, without any risk of deteriorating the sheet. Rolling up the sheet avoids creating irreversible folds or creases that would spoil the remembered plane shape of the sheet. In this first embodiment, the flexible sheet 3 is made from one single-piece sheet, such as a sheet of plastics material.

Reference is made below to FIGS. 4a to 6b in order to describe the second embodiment that does not form part of the invention. As can be seen in FIG. 6a, the flexible sheet 3 presents a shape that is substantially rectangular with top, side, and bottom edges 31, 32, 33′ that are substantially rectilinear. The side edges 32 may be situated in the proximity of, or in contact with, the side wall 13 of the reservoir 1. The top edge 31 is arranged at the fluid inlet 21, while the bottom edge 33′ comes almost down to the bottom end of the dip tube 22. It can thus be said that the dip tube 22 is covered almost completely by the flexible sheet 3. This is even more true when the flexible sheet 3 is made from two films 3a and 3b, each of which extends on a respective side of the dip tube 22, as can be seen in FIGS. 4b, 5b, and 6b.

In order to insert the flexible sheet 3 through the neck 11, provision is made to deform it beforehand into a deformed configuration. The simplest way is to roll it up around the dip tube, as shown in FIG. 4a. It is also possible to envisage deforming it like a concertina. The flexible sheet 3 is held in this deformed configuration by a holding ring 6 that defines a central passage having a diameter that is less than or equal to the constricted opening 12 of the neck 11. In FIG. 4a, it can be seen how the flexible sheet 3 is rolled-up around the dip tube 22, and held in this state by the holding ring 6. The flexible sheet 3 can then be inserted through the neck 11, as shown in FIG. 5a. It is advantageous for the holding ring 6 to be arranged substantially half way up the height of the flexible sheet 3. By continuing to drive the flexible sheet 3 through the neck 11 from the position shown in FIG. 5a, it can easily be understood that the holding ring 6 comes into contact with the top edge of the neck 11. In the invention, the holding ring 6 is used as a neck gasket, making it possible to provide sealing between the fastener ring 5 and the neck 11. To do this, it is necessary for the dispenser member 2 to present a diameter that is smaller than the central passage of the holding ring 6. At the end of mounting, as shown in FIG. 6a, the holding ring 6 is arranged between the ring 5 and the neck 11, and the flexible sheet 3 is deployed, in full or in part, inside the reservoir 1.

It should be observed that the holding ring 6 does not constitute a part that is additional to the dispenser, given that it then serves as a neck gasket. It should even be considered that the flexible sheet 3 in its deformed configuration serves as a provisional support for the neck gasket 6. Naturally, it is possible to imagine other embodiments for the holding ring 6, without going beyond the ambit of the invention. It should also be observed that the use of such a holding ring 6 makes it possible to make flexible sheets 3 with a wide range of shapes, given that their bottom edges do not need to be shaped in appropriate manner, as in the first embodiment. However, the first embodiment presents the advantage that it is not necessary to pre-arrange the flexible sheet 3 in a deformed configuration before inserting it through the neck, since it is deformed automatically as a result of its portion 34, that penetrates into the constricted opening, even though the sheet is still in its plane rest configuration.

In both embodiments shown in the figures, the flexible sheet is fastened directly to the dip tube.

Without going beyond the ambit of the invention and of the claims, it should be considered that the dip tube is provided with a flexible sheet, even when the flexible sheet is fastened to an element that is adjacent to, or that surrounds, the dip tube, like a tube that surrounds the dip tube, at least in part, or an insert that is fastened directly or indirectly to the dip tube, and that extends inside the reservoir beside the dip tube. Specifically, it is possible to envisage making a dip tube that is provided with an “overtube” that surrounds the dip tube: the sheet may thus be fastened on the overtube.

1. A method of assembling a fluid dispenser comprising:
a fluid reservoir including a neck that defines a constricted opening that communicates with an inside volume of greater size; and
a dispenser member, such as a pump or a valve, including a fluid inlet that is provided with a dip tube;
a substantially-plane flexible sheet having shape memory, the sheet extending along a dip tube and being fastened to the dip tube, the sheet presenting a transverse dimension, in the direction that is perpendicular to the dip tube, that is greater than the dimension of the constricted opening, such that the sheet must be caused to take up a deformed configuration in order to pass through the neck, and must then relax into a substantially-plane rest configuration inside the inside volume;
the method being characterized in that the sheet presents a bottom edge having a portion that defines a bottom point that is situated at the dip tube, the bottom point and the dip tube being positioned in the opening, with the sheet in the rest configuration so that, in said rest configuration, the portion penetrates into the constricted opening in such a manner as to initiate the deformation of the sheet, so as to bring it subsequently into its deformed configuration.

2. A method according to claim 1, wherein the sheet is rolled up around a dip tube in its deformed configuration.

3. A method according to claim 2, wherein the bottom edge of the sheet is rounded.

4. A method according to claim 2, wherein the bottom edge of the sheet is pointed.

5. A fluid dispenser comprising:
a fluid reservoir including a neck that defines a constricted opening that communicates with an inside volume of greater size; and
a dispenser member, such as a pump or a valve, including a fluid inlet that is provided with a dip tube;
a substantially-plane flexible sheet having shape memory, the sheet extending along a dip tube and being fastened to the dip tube, the sheet presenting a transverse dimension, in the direction that is perpendicular to the dip tube, that is greater than the dimension of the constricted opening, such that the sheet must be caused to take up a deformed configuration in order to pass through the neck, and must then relax into a substantially-plane rest configuration inside the inside volume;
the dispenser being characterized in that the sheet presents a bottom edge having a portion that defines a bottom point that is situated at the dip tube, the bottom point and the dip tube being positioned in the opening, with the sheet in the rest configuration so that, in said rest configuration, the portion penetrates into the constricted opening in such a manner as to initiate the deformation of the sheet, so as to bring it subsequently into its deformed configuration.

6. A dispenser according to claim 1, wherein the sheet extends along the dip tube.

7. A dispenser according to claim 1, wherein the sheet comprises at least two films, each of which extends on a respective side of the dip tube.

8. A dispenser according to claim 1, wherein the sheet is fastened to the dip tube by adhesive, by heat-sealing, by clamping, or by clipping.

9. A dispenser according to claim 1, wherein the dip tube is transparent inside the fluid of the reservoir.
